(19) United States
(12) Patent Application Publication
(10) Pub. No.: US 2026/0356546 A1
(43) Pub. Date: Nov. 12, 2026

(54) LID TO BE USED TOGETHER WITH A CONTAINER AS WELL AS SET OF CONTAINER AND LID AND A METHOD FOR MANUFACTURING SUCH A LID

(71) Applicant: Yangi AB, Varberg (SE)

(72) Inventor: Adam JOHANSSON, Falkenberg (SE)

(73) Assignee: Yangi AB, Varberg (SE)

(21) Appl. No.: 19/486,827

(22) PCT Filed: May 21, 2024
(86) PCT No.: PCT/EP2024/063899

§ 371 Date: Nov. 21, 2025

(30) Foreign Application Priority Data
May 22, 2023 (EP) 23174541.5

(51) Int. Cl. B65D 43/02; B31D 5/02; B65D 21/02

(52) U.S. Cl. CPC B65D 43/0222; B31D 5/02; B65D 21/0217; B65D 2543/00092; B65D 2543/00268; B65D 2543/00527; B65D 2543/00537; B65D 2543/00648; B65D 2543/00759

(57) ABSTRACT

A method for manufacturing a lid made of cellulose fibers, and a set including a container and a lid. The container has a container wall and an opening defined by a circumferential rim having a circular outer rim surface. The lid has a cover plate configured to cover the opening and a skirt connected to the cover plate and configured to engage the circular outer rim surface. A first circumferential segment of an inner surface of the skirt has a cylindrical shape. The cylinder-shaped first circumferential segment has a non-circular shape, and the inner circumference of the first circumferential segment is equal to or less than 102% of the circumference of the circular outer rim surface of the container and is equal to or more than 98% of the circumference of the circular outer rim surface of the container.

### TECHNICAL FIELD OF THE INVENTION

The present invention relates in general to the field of rigid cellulose products having non-flat general shape, wherein the rigid cellulose products are intended to be used as single/multiple use disposable articles/products in order to replace corresponding plastic products. The present invention relates specifically to a lid configured to be used together with a container and relates specifically to a set comprising a container and a lid, wherein the lid is constituted by such a rigid cellulose product. The present invention also relates to a method for manufacturing such a lid.

The container comprises a container wall and an opening defined by a circumferential rim of the container wall, wherein said rim has a circular outer rim surface. The lid is made of cellulose fibers, wherein said lid comprises a cover plate configured to cover the opening of the container and a skirt connected to the cover plate and configured to engage the circular outer rim surface of the rim of the container, and wherein a first circumferential segment of an inner surface of the skirt has cylindrical shape, said first circumferential segment being located intermediate a second circumferential segment of the inner surface of the skirt and the cover plate of the lid.

### BACKGROUND OF THE INVENTION

There are many situations where it is desirable to provide three-dimensional (3D) shaped objects made of sustainable materials, such as biomaterials, instead of plastic/polymer materials. A biomaterial commonly used for packaging is wet moulded pulp based on cellulose fibres. Such wet moulded pulp has the advantage of being considered as a sustainable packaging material, since it is produced from biomaterials and can be recycled after use. Wet moulded pulp comprises more or less only water and separated cellulose fibers, and consequently, wet moulded pulp has been popular to use for packaging applications and as single/multiple use disposable articles.

However, a common disadvantage with all wet-forming techniques is the need for large amounts of water during the preparations of the cellulose pulp and the need for drying during the manufacturing/moulding of the product, which is time as well as energy consuming step leading to low production speed and substantial high investment cost in machines and tooling. Meaning that the wet-forming techniques are not feasible to replace fossil-based alternatives neither in small nor large scale production of rigid cellulose products. Thereto, the aesthetical and mechanical properties of a wet-moulded cellulose product are hard to control with desirable precision, due to un-uniform cellulose pulp and due to the wet moulding manufacturing technique per se.

Therefore many actors/companies, starting a few decades ago, have changed their focus and investments towards dry-forming techniques wherein rigid cellulose products are manufactured from separated cellulose fibres that are introduced into a product forming unit in the shape of a dry cellulose blank/web, wherein the cellulose blank is formed into the shape of the intended cellulose product and wherein the cellulose fibres are bonded to each other using heat and pressure in the product forming unit. The dry-forming techniques comprises different steps of generating an air-laid cellulose blank, that is fed into the product forming unit. Alternative dry-forming techniques makes use of a paperboard/cardboard cellulose blank, that is fed into the product forming unit.

The technical field of dry manufacturing rigid cellulose products having non-flat general shape, such as trays, lids, or the like, i.e. wherein the forming/pressing is performed in one step using a forming tool having a male mould part and a female mould part configured to cooperate with each other, is well known. Well known in connection with air-laid cellulose blanks as well as with cardboard cellulose blanks.

When using a traditional forming mould for manufacturing rigid cellulose products having non-flat general shape, wherein the pressing movement is one reciprocating movement in one direction, it is impossible to create negative angles or undercut grooves/features in the products. However, this is a necessary feature/function when creating lids of cellulose fibres.

US 2013/0334228 discloses a paper lid configured to be used together with a container/cup having a circular rim. Wherein the paper lid is manufactured from a cardboard cellulose blank. The lid comprises a cover plate and a skirt extending from the cover plate. The lid comprises a bead, ring, undercut groove, or the like on the inside of the skirt, configured to engage the underside of a rim/brim of the container. However, in order to obtain a bead, ring, undercut groove, or the like on the inside of the skirt, the manufacturing of the lid becomes much more complicated and requires several pressing/forming steps as disclosed in US 2013/0334228. Alternatively the manufacturing requires complicated forming mould design as disclosed in EP 3736099 that among other things disclose manufacturing of a rigid cellulose product having an undercut groove, wherein the forming of the cellulose product and undercut groove is based on a flexible mould part/half asserting isostatic pressure to the entire air-laid cellulose blank. This technique has its obvious drawbacks relating to the use of a flexible mould part during the pressing/forming step, wherein the flexible mould part will wear much faster than a metal/steel mould part, and the flexible mould part may have different material characteristics throughout the body and/or over time. The forming units used in the abovementioned patent applications requires moulds that are complex, costly and highly specialized for a single product design, thus resulting in a higher tooling development and manufacturing cost and increasing the complexity of the pressing/forming setup/machine.

When using moulded plastic lids, the circular lids usually have a much smaller circumference than the circular rim of the container in order to utilize the internal elasticity in the plastic material in the skirt of the lid in the circumferential direction in order to obtain a squeeze fit around the rim of the container, in addition to the snap/holding effect of an undercut groove. The internal elasticity of the plastic material will remain over time. However, the internal elasticity in a lid made from cellulose fibers will decrease rapidly/immediately, whereby such a squeeze fit design in the circumferential direction of the skirt of the lid cannot be applied for lids made of cellulose fibres.

There is a need in the art for a reliable, cheap and efficient dry-forming technique/process for dry manufacturing rigid cellulose products having non-flat general shape, to be used as lids for various containers having a circular rim.

### OBJECT OF THE INVENTION

The present invention aims at obviating the aforementioned and other disadvantages and failings of previously known methods for dry manufacturing rigid cellulose lids and of known lids, and at providing an improved method for dry manufacturing rigid cellulose lids having non-flat general shape and improved lids made of cellulose fibres.

A primary object of the present invention is to provide an improved lid made of cellulose fibres and a method for dry forming/manufacturing rigid cellulose lids having non-flat general shape, wherein the environmental benefits as well as time and energy saving benefits of conventional dry-forming techniques are maintained.

### SUMMARY OF THE INVENTION

According to the invention at least the primary object is attained by means of the initially defined set of container and lid, and method having the features defined in the independent claims. Preferred embodiments of the present invention are further defined in the dependent claims.

According to the present invention, there is provided a lid as well as a set of container and lid, wherein the container has a circular outer rim surface, and wherein the cylinder-shaped first circumferential segment of the skirt of the lid has non-circular shape, and in that the inner circumference of the first circumferential segment of the inner surface of the skirt is equal to or less than 102% of the circumference of the circular outer rim surface of the container and is equal to or more than 98% of the circumference of the circular outer rim surface of the container, wherein the non-circular cylinder-shaped first circumferential segment of the inner surface of the skirt of the lid is configured to engage the circular outer rim surface of the rim the container.

Thus, the present invention is based on the insight of utilizing a non-circular lid to be used together with a circular container, at the same time as the circumference of the skirt of the lid is more or less the same as the circumference of the circular rim of the container. Thereby, the skirt of the lid will experience no or minimal tensile force in the circumferential direction, but the lid is kept in place due to the difference in overall shape between the skirt of the lid and the rim of the container.

The present invention provides the advantage that a lid made of cellulose fibres may be designed without undercut groove/feature, whereby such inventive lids may be formed/pressed in a traditional forming mould wherein the pressing movement is one reciprocating movement in one direction using solid mould parts.

According to various example embodiments of the present invention the first circumferential segment of the skirt of the lid comprises four equidistantly distributed radii, wherein at least one radius of said four radii is the shortest radius of the first circumferential segment and is less than the radius of the circular outer rim surface of the container and is equal to or more than 98% of the radius of the circular outer rim surface of the container.

According to various example embodiments of the present invention at least one other radius of the four radii is the longest radius of the first circumferential segment and is more than the radius of the circular outer rim surface of the container and is equal to or less than 102% of the radius of the circular outer rim surface of the container.

According to various example embodiments of the present invention the skirt of the lid has an outer surface located opposite the cylindrical first circumferential segment of the inner surface of the skirt, wherein said outer surface has truncated cone shape.

According to a second aspect of the present invention, there is provided a method for manufacturing a lid made of cellulose fibres, wherein the lid is configured to engage a circular outer rim surface of a circumferential rim of a container, the method comprises the steps of:
forming a cover plate and a skirt connected to the cover plate, wherein a first circumferential segment of an inner surface of the skirt has cylindrical shape and is located intermediate a second circumferential segment of the inner surface of the skirt and the cover plate, and
forming the cylinder-shaped first circumferential segment of the skirt into non-circular shape, wherein the inner circumference of the first circumferential segment of the inner surface of the skirt is equal to or less than 102% of the circumference of the circular outer rim surface of the container and is equal to or more than 98% of the circumference of the circular outer rim surface of the container.

Further advantages with and features of the invention will be apparent from the following detailed description of preferred embodiments.

### BRIEF DESCRIPTION OF THE DRAWINGS

A more complete understanding of the abovementioned and other features and advantages of the present invention will be apparent from the following detailed description of preferred embodiments in conjunction with the appended drawings, wherein:

FIG. 1 is a schematic illustration of a production line or apparatus for dry manufacturing rigid cellulose products,

FIG. 2 is a schematic illustration of a moulding tool, wherein a cellulose blank is loaded therein,

FIG. 3 is a schematic illustration of the moulding tool according to FIG. 2, wherein the cellulose blank is pressed into final rigid non-flat general shape,

FIG. 4 is a schematic illustration of the moulding tool according to FIGS. 2 and 3, wherein the rigid cellulose product is released,

FIG. 5 is a schematic illustration of an inventive set of container and lid from the side, wherein the lid is shaped according to a first embodiment, and wherein the lid and container are partly in cross-section,

FIG. 6 is a schematic illustration of a stack of containers from the side, wherein the lid and containers are partly in cross-section,

FIG. 7 is a schematic cross-sectional side view of an inventive lid according to a second embodiment,

FIG. 8 is an enlarged partial side view of the lid according to FIG. 7,

FIG. 9 is a schematic cross-sectional side view of an inventive lid according to a third embodiment,

FIG. 10 is an enlarged partial side view of the lid according to FIG. 9,

FIG. 11 is a schematic perspective view from below of the lid according to FIGS. 7 and 8,

FIG. 12 is a bottom view of the lid according to FIG. 11,

FIG. 13 is a schematic perspective view from above of a lid according to a fourth embodiment, and

FIG. 14 is a schematic cross-sectional side view of the lid according to FIG. 13.

### DETAILED DESCRIPTION OF PREFERRED EMBODIMENTS OF THE INVENTION

As used herein, the term “air/dry moulding/forming or air/dry laying/laid” means a well-known method according to which separated cellulose fibres are formed into a cellulose blank/sheet.

In air-laying technique, small/short fibres having a normal length in the range of 0.5 to 70 mm, for instance 1 to 50 mm, are separated and captured by an air stream/flow, and then laid on/applied to a forming mesh/surface, usually using a low pressure at the other side of the mesh/surface. The terms “air/dry laying” and “air/dry moulding” are used interchangeably herein. The cellulose fibre carrying air flow may be generated by suitable device located upstream and/or downstream the forming mesh/surface.

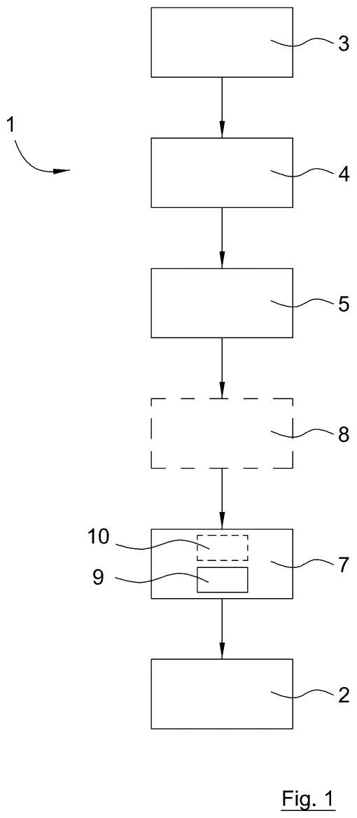

Reference is initially made to FIGS. 1-4. FIG. 1 disclosing a schematic illustration of a generic production line/apparatus for dry manufacturing rigid cellulose products, generally designated 1. The production line 1 is configured for manufacturing rigid cellulose products, generally designated 2, having essentially non-flat general shape from separated cellulose fibres. Such a production line 1 may be arranged and set-up according to different well-known ways.

Cellulose raw material 3 is provided to the production line, and is fed to a separating/disintegrating unit 4 in order to obtain individualized/separated cellulose fibres. The separated cellulose fibres are thereafter transported by an air stream/flow to a dispenser of a cellulose blank/sheet forming unit 5. The cellulose fibres are laid by the dispenser on a moving or stationary perforated surface of the cellulose blank forming unit 5. The cellulose fibre carrying air flow may be generated by suitable device located upstream and/or downstream the perforated surface. Thereafter the generated cellulose blank 6 is transported to a product forming unit 7, whereby rigid cellulose products 2 are formed and discharged from the product forming unit 7. The rigid cellulose product 2 is in this embodiment made of a heat-pressed sheet of air-laid cellulose fluff comprising cellulose fibers.

The cellulose blank forming unit 5 may be configured to generate a continuous cellulose blank and/or discontinuous/discrete cellulose blanks. Preferably discontinuous/discrete cellulose blanks 6 are fed into the product forming unit 7.

The cellulose raw material 3 may be in the form of reeled pulp or paper, bale of cellulose pulp, paper, etc. and/or sheets of paper, cellulose pulp, etc. In case said cellulose raw material 3 is in the form of sheets and/or reeled pulp or paper, it can be fed directly into the separating unit 4. However, in case said cellulose raw material 3 is in the form of a bale or compact stacks of sheets, etc. one or more shredders and/or one or more additional separating/disintegrating units 4 may be necessary to be used for separating and dosing said cellulose raw material 3 from said bale or sheets in smaller quantities. The shredder(s) prepare cellulose raw material 3 to be accepted by said separating unit 4. The separating unit 4 disintegrates the cellulose raw material 3 into separated cellulose fibres. Said one or plurality of shredder(s) are arranged before said one or a plurality of separating unit(s) 4, so that an output of one of said shredder is connected to an input of one of said separating units 4. The shredders may be arranged in parallel to each other or in series with each other, and the disintegrating units 4 may be arranged in parallel to each other or in series with each other. The shredders and the disintegrating units 4 together constitute a cellulose fibre separating unit, arranged upstream the cellulose blank forming unit 5.

Said cellulose raw material 3 may be constituted by virgin cellulose fibres and/or recycled cellulose fibres and may originate from wood pulps such as kraft pulp, sulphite pulp, mechanical pulp, thermomechanical pulp (TMP), chemical treated mechanical pulp, chemi-thermomechanical pulp (CTMP), and/or from non-wood pulps such as bagasse, bamboo, abaca, hemp, flax, cotton.

The separating unit 4 may according to various embodiments be constituted by a hammer mill. In said separating unit 4 the cellulose raw material is separated into fibres having a normal length in the range of 0.5-70 mm. The length of said fibres may be customized by adjusting the internal properties of the separating unit 4 and/or by choosing a different separating unit 4 and/or choosing different cellulose raw material. The fibre length for wood pulp is according to various embodiments in the range 0.5-4 mm, preferably in the range 1.7-3.6 mm. According to various embodiments the fibre length for non-wood pulp is in the range 0.5-70 mm.

The production line 1 may comprise a pre-compression and/or imprinting unit 8, located downstream the cellulose blank forming unit 5 and upstream the product forming unit 7. In the pre-compression and/or imprinting unit 8, an air-laid fluffy cellulose blank having a first thickness may be compressed into a cellulose blank having a second thickness, wherein said second thickness is thinner than said first thickness, and/or may be provided with an imprinted pattern. During the pre-compression/imprinting the cellulose blank is made more coherent and easier to handle, since the pre-compression/imprinting generates internal bindings between individual cellulose fibres preventing mutual separation of the cellulose fibres.

The product forming unit 7 comprises a press unit 9, and may optionally comprise a pre-heating unit 10 arranged upstream the press unit 9. According to various example embodiments said cellulose blank 6 may be heated to an elevated temperature before being fed into the press unit 9 of the product forming unit 7. In such embodiment(s) where the cellulose blank is preheated before being fed into the press unit 9, said press unit 9 may or may not comprise heating. According to various example embodiment said press unit 9 may be a heated press unit 9 for heating said cellulose blank 6 during pressing. In the case of a heated press unit 9, preheating of said cellulose blank using a pre-heating unit 10 is optional. According to various example embodiments preheating of the cellulose blank in said pre-heating unit 10 may be combined with a heated press unit 9. Having a pre-heating unit 10 in combination with a heated press unit 9 will speed up the manufacturing process in the product forming unit 7, and improve the quality/rigidity of the final rigid cellulose product 2. In the product forming unit 7 the cellulose blank 6 is heated to a temperature in the range 120-200 °C in order to obtain adequate rigidity and strength in the final cellulose product 2. Thus, in this embodiment the rigid cellulose product 2 is made of a heat-pressed sheet of air-laid cellulose fluff comprising cellulose fibers.

Reference is now especially made to FIGS. 2-4. The press unit 9 comprises a moulding tool having a first mould part 11 and a second mould part 12, wherein at least one of the first mould part 11 and the second mould part 12 is/are displaceable back and forth in relation to each other, in order to exert pressure to the cellulose blank 6 loaded therebetween. In the figures the mutual displacement is disclosed as being vertical, however the mutual displacement may be horizontal or any other suitable angle. The cellulose blank 6 loaded into the moulding tool, is constituted by an air-laid cellulose blank 6. The air-laid cellulose blank 6 may be generated upstream the product forming unit 7 in the same production line and provided to the product forming unit 7, or may be generated at a separate location and provided to the product forming unit 7 via intermediate handling and storage.

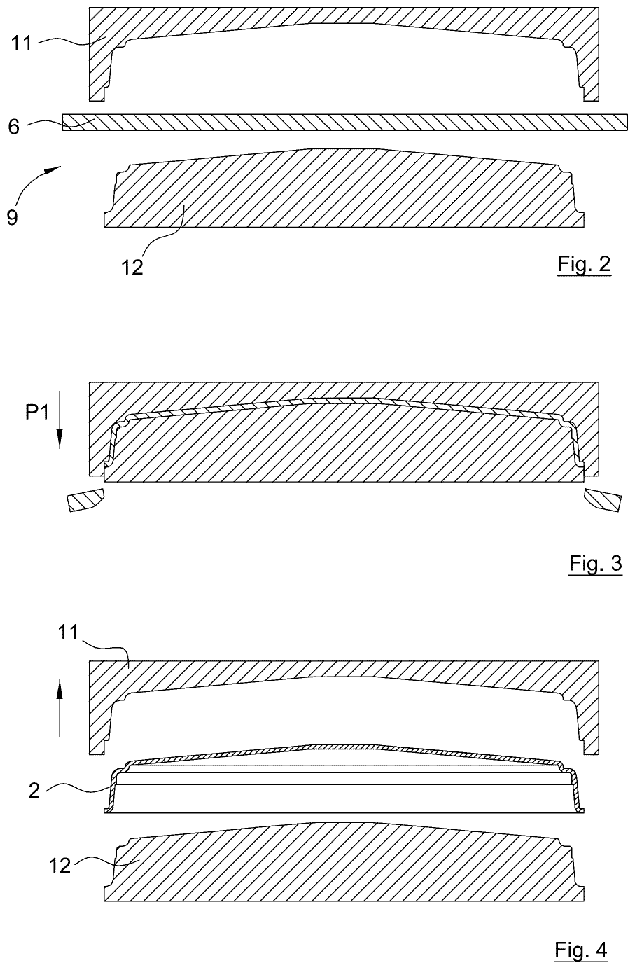

According to various embodiments the first mould part 11 of the moulding tool is a female mould part, i.e. having a main recess for receiving the cellulose blank 6, and the second mould part 12 of the moulding tool is a male mould part, i.e. having a main protrusion for cooperation with said recess of the first/female mould part, such that the cellulose blank 6 is pressed into a final rigid non-flat shape. During the pressing, disclosed in FIG. 3, a predetermined pressure P1 is applied by the moulding tool between the recess and the protrusion. Thus, the rigid cellulose product 2 obtains its final rigid non-flat shape, which may have any conceivable non-flat design/shape. In the disclosed embodiment the edges of the rigid cellulose product 2 are trimmed concurrently with the pressing/forming of the rigid cellulose product 2.

The predetermined pressure P1 is in the range 40-10000N/cm², preferably in the range 100-4000N/cm². According to various embodiments said predetermined pressures are above 400N/cm², and according to various embodiments said predetermined pressures are below 2000N/cm². According to various embodiments the cellulose blank 6 loaded into the press unit 9 is constituted by a paperboard/cardboard cellulose blank, instead of the air-laid cellulose blank described above.

In FIG. 4 the cellulose product 2 is released by opening the moulding tool.

The rigid cellulose product is hereinbelow constituted by an inventive lid 2 made of cellulose fibers. The above disclosure concerning a rigid cellulose product is fully applicable to the lid 2.

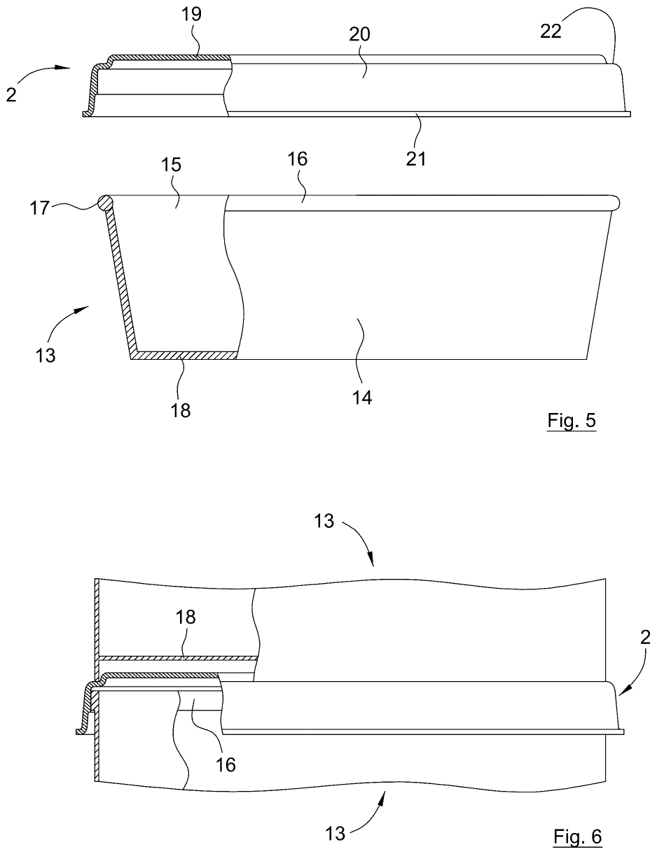

Reference is now made to FIG. 5 disclosing a set constituted by a container 13 and a lid 2, wherein the lid is shaped according to a first embodiment, and FIG. 6 disclosing a stack of two containers 13 wherein the lower container 13 is closed by a lid 2 and the upper container 13 is placed on top of the lid 2 of the lower container 13.

The container 13 comprises a container wall 14 and an opening 15 defined by a circumferential rim/brim 16 of the container wall 14, wherein said rim 16 has a circular outer rim surface 17. Thus, the outer rim surface 17 of the rim is the circumferential radially most outer surface of the rim 16. According to FIG. 5 embodiment the rim 16 has an essentially round cross-sectional area wherein the circular outer rim surface 17 is more or less constituted by a circumferential line. According to FIG. 6 embodiment the rim 16 has an essentially square shaped cross-sectional area. According to the disclosed embodiments of FIG. 6, the container wall 14 is cylindrical and has a circular cross section in the radial plane, like a tin can or a tube for crisps. The cylinder wall 14 may have truncated cone shape, narrowing in the direction away from the opening 15, in accordance with FIG. 5 embodiment, or may have complete cone shape. Thereby the containers 13 are stackable one inside the other when they are empty, like mugs/cups/trays. The cross section of the container wall 14 in the radial plane may have any suitable shape and may differ in shape and/or dimension along the axial extension of the container 13, as long as the outer rim surface 17 of the rim 16 is circular.

The cylinder 13 may comprise a fixed bottom 18, or may be open in both axial ends, i.e. having two opposite openings 15, like a tube for posters. The bottom 18 may be located at the very lower end of the container wall 14, according to FIG. 5 embodiment, or be located at a distance from the lower end of the container wall 14, according to FIG. 6 embodiment, or a combination thereof. According to the disclosed embodiments, the circular outer rim surface 17 of the rim 16 of the container 13 is located radially outside the envelope surface of the container wall 14. However, it is feasible that the circular outer rim surface 17 of the rim 16 is in flush with the envelope surface of the container wall 14. The container 13 may be made of any suitable and rigid material or combination of materials, such as cellulose, paperboard, metal, glass, plastic, etc.

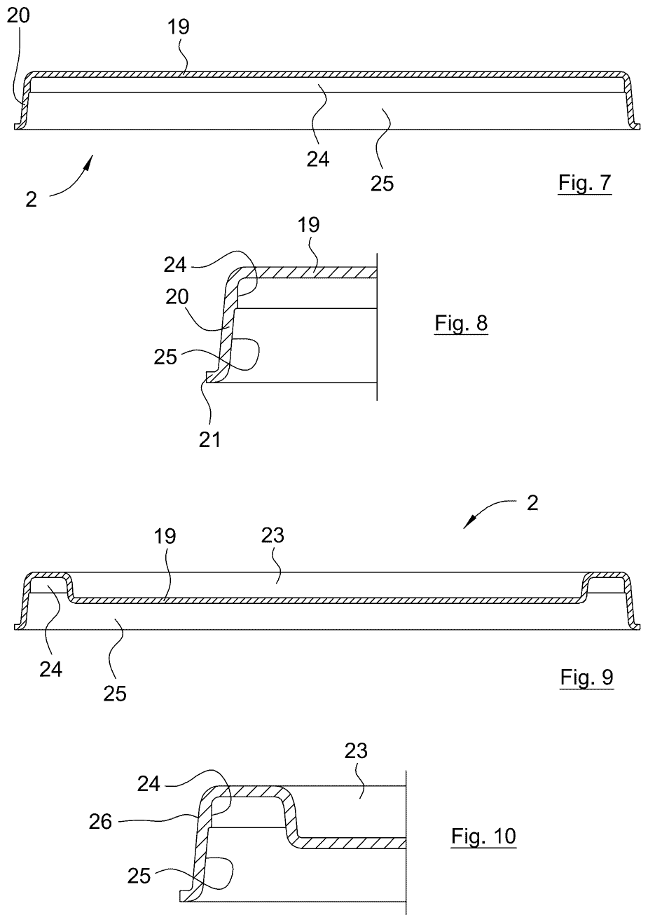

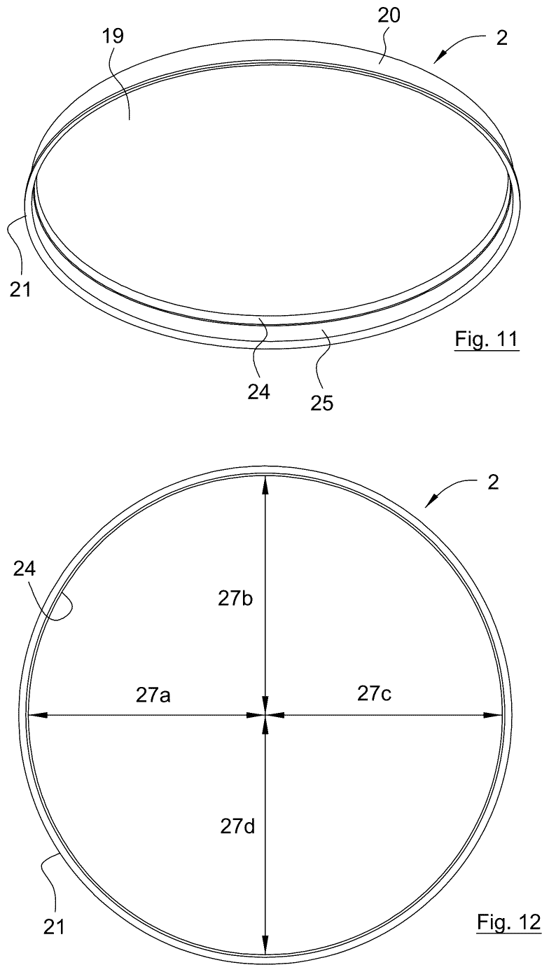

Reference is now also made to FIGS. 7-14 disclosing different embodiments of the lid 2 and different features of the lid 2. The lid 2 is a rigid cellulose product thermoformed from an air-laid cellulose blank or from a paperboard cellulose blank, i.e. is made of cellulose fibers. The lid 2 comprises a cover plate 19 configured to cover the opening 15 of the container 13, and a skirt 20 connected to the cover plate 19 and configured to engage the circular outer rim surface 17 of the rim 16 of the container 13. According to the various embodiments, the lid 2 comprises a radially extending flange 21 at the lower end of the skirt 20, in order to simplify closing and opening of the container 13. Said flange 21 is optional. It shall also be pointed out that the flange 21 may be replaced by or supplemented by radially extending lugs (not disclosed) to further simplify closing and opening of the container 13.

FIGS. 5 and 6 disclose a lid 2 according to a first embodiment, wherein the cover plate 19 has a circumferential step 22 at the periphery of the cover plate 19. Thereby the cover plate 19 is provided a convex general shape, and one purpose is to align and support the upper container 13 in a stack/pile of containers 13 having cylindrical container wall 14 and the bottom 18 offset upwards as disclosed in FIG. 6. The step 22 also provides stability to the lid 2. The cover plate 19 may in the central part thereof comprise further projections and/or recesses.

FIGS. 7, 8 and 11 disclose a lid 2 according to a second embodiment, wherein the cover plate 19 is flat. It is advantageous to have as few sharp corners/edges as possible since such areas are crack-prone areas during the forming/moulding step. The cover plate 19 may comprise projections and/or recesses.

FIGS. 9 and 10 disclose a lid 2 according to a third embodiment, wherein the cover plate 19 has a central recess 23. Thereby the cover plate 19 is provided a concave general shape, and one purpose is to align and support the upper container 13 in a stack/pile of containers 13 having truncated cone shaped container wall 14 as disclosed in FIG. 5. The recess 23 also provides stability to the lid 2. The cover plate 19 may in the central recess 23 thereof comprise further projections and/or recesses.

It shall be pointed out that the step 22 according to the first embodiment of the lid 2 may be combined with the recess 23 according to the third embodiment of the lid 2, in order to obtain a more versatile and multi-application lid 2.

FIGS. 13 and 14 disclose a lid 2 according to a fourth embodiment, wherein the cover plate 19 has a circumferential step 22 at the periphery of the cover plate 19 and thereto a dome-shaped centre part of the cover plate 19, i.e. the cover plate 19 has convex general shape. The step 22 is optional in this embodiment. One purpose of the dome-shaped centre part of the cover plate 19 is to provide stability to the lid 2, another purpose is to enlarge the closed cavity/volume of the container 13 and lid 2. The dome-shaped centre part of the cover plate 19 also entails that by being deformed when applying the lid 2 to the container 13, the skirt 20 may be distorted in the radial direction without damaging the cover plate 19 and/or the skirt 20 and at the same time provides a biasing force in the radial direction to the skirt 20. The dome-shaped centre part of the cover plate 19 may be semi-spherical and/or may be composed by several generally flat tiles as disclosed in FIGS. 13 and 14.

Reference is now made to FIGS. 8 and 10. Common for all embodiments of the lid 2 is that a first circumferential segment 24 of an inner surface of the skirt 20 has cylindrical shape, i.e. an axially/vertically extending surface segment. The first circumferential segment 24 of the inner surface of the skirt 20 is located intermediate a second circumferential segment 25 of the inner surface of the skirt 20 and the cover plate 19. The second circumferential segment 25 is adjacent the radial flange 21 of the skirt 20. Preferably the first circumferential segment 24 is adjacent the cover plate 19. However it is feasible that the skirt 20 comprises a third circumferential segment of the inner surface of the skirt 20 located intermediate the first circumferential segment 24 and the cover plate 19. The cylinder-shaped first circumferential segment 24 of the inner surface of the skirt 20 is configured to engage the circular outer rim surface 17 of the rim 16 of the container 13.

It is essential that the cylinder-shaped first circumferential segment 24 of the skirt 20 of the lid 2 has non-circular shape, to engage the circular-shaped outer rim surface 17 of the rim 16 of the container 13. The difference in shape and dimensions in the radial plane secures the engagement between the lid 2 and the container 13.

The inner circumference of the first circumferential segment 24 of the inner surface of the skirt 20 is equal to or less than 102% of the circumference of the circular outer rim surface 17 of the container 13, and is equal to or more than 98% of the circumference of the circular outer rim surface 17 of the container 13. Thus, the inner circumference of the non-circular first circumferential segment 24 is more or less the same as the circumference of the circular outer rim surface 17, whereby there is low internal tensions in the bindings between individual cellulose fibres at the skirt 20 of the lid 2. Thus, the inner circumference of the first circumferential segment 24 of the inner surface of the skirt 20 is in the range 98%-102% of the circumference of the circular outer rim surface 17 of the container 13.

According to various embodiments, the inner circumference of the non-circular first circumferential segment 24 is equal to or less than 101% of the circumference of the circular outer rim surface 17, and most preferably equal to or less than the circumference of the circular outer rim surface 17. Thus, the inner circumference of the first circumferential segment 24 of the inner surface of the skirt 20 is preferably in the range 100%-101% of the circumference of the circular outer rim surface 17 of the container 13.

According to various embodiments, the axial height of the first circumferential segment 24 of the inner surface of the skirt 20 is equal to or more than 1 mm and equal to or less than 5 mm, preferably equal to or more than 1.5 mm and equal to or less than 3 mm. The axial height of the first circumferential segment 24 has to be large enough to be able to engage the outer rim surface 17 of the container 13.

According to various embodiments, the skirt 20 of the lid 2 has an outer surface 26 located opposite the cylindrical first circumferential segment 24 of the inner surface of the skirt 20, wherein said outer surface 26 has truncated cone shape. Thus, the thickness of the skirt 20 between the conical outer surface 26 and the cylindrical first circumferential segment 24 of the inner surface will vary from large, adjacent the second circumferential segment 25 of the inner surface of the skirt 20, to small, at the cover plate 19. The difference in thickness entails that the density and rigidity of the skirt 20 will vary accordingly. Thereby the rim 16 of the container 13 may slightly penetrate into the slightly softer surface of the first circumferential segment 24, and thereby the lid 2 is kept harder/firmer to the rim 16 of the container 13.

According to various embodiments, the second circumferential segment 25 of the inner surface of the skirt 20 has truncated cone shape, in order to facilitate closing of the lid 2. Thus, the rim 16 of the container 13 is easily guided by the truncated cone-shaped second circumferential segment 25 towards the first circumferential segment 24. Thereafter the lid 2 is forced downwards at the same time as the first circumferential segment 24 engage the outer rim surface 17.

According to various embodiments, the entire outer surface of the skirt 20, except the radial flange 21, is in the shape of a truncated cone, in order to obtain correct pressing/forming of the skirt 20 of the lid 2 during one directional pressing in the mould.

According to various embodiments, the second circumferential segment 25 of the inner surface of the skirt 20, as well as the outer surface of the skirt 20, has circular shape. Thus, the lid 2 is and behaves as a circular lid 2 and may be stacked without having to consider rotational position/orientation of the individual lids 2, since the outer surface of the skirt 20 only engage the second circumferential segment 25 of the inner surface. Thus, only the first circumferential segment 24 of the lid 2 has to have non-circular shape. Alternatively, the second circumferential segment 25 of the inner surface of the skirt 20, and/or the outer surface of the skirt 20, may have non-circular shape in accordance with the first circumferential segment 24.

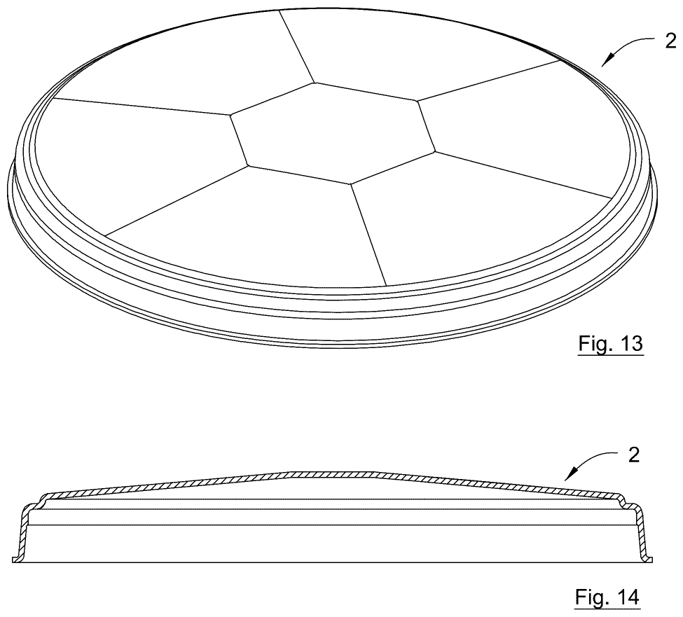

Reference is now made to FIG. 12, disclosing a lid 2 from below. According to various embodiments, the first circumferential segment 24 comprises four equidistantly distributed radii 27a-27d, wherein at least one radius 27a of said four radii is the shortest radius of the first circumferential segment 24, and is less than the radius of the circular outer rim surface 17 of the container 13, and is equal to or more than 98% of the radius of the circular outer rim surface 17. Preferably, said at least one radius 27 a of said four radii that is the shortest, is equal to or more than 99% of the radius of the circular outer rim surface 17. According to various embodiments, the radius 27c that is located opposite the at least one radius 27a of said four radii that is the shortest radius, has the same length as said at least one radius 27a.

According to various embodiments, at least one other radius 27b of the four radii is the longest radius of the first circumferential segment 24 and is more than the radius of the circular outer rim surface 17 of the container 13 and is equal to or less than 102% of the radius of the circular outer rim surface 17. Preferably, said at least one other radius 27b of the four radii that is the longest, is equal to or less than 101% of the radius of the circular outer rim surface 17. According to various embodiments, the radius 27d that is located opposite the at least one other radius 27b of said four radii that is the largest radius, has the same length as said at least one other radius 27b.

Preferably the non-circular first circumferential segment 24 has oval shape, having one large diameter (radii 27b and 27d) and one small diameter (radii 27a and 27c) perpendicular to the large diameter. Alternatively, two mutually adjacent radii (27a and 27d) have the same length, and the other two mutually adjacent radii (27b and 27c) have the same length.

According to various embodiments, three radii 27b-27d has the same length and the fourth radius 27a is shorter (or longer). Preferably, the radius of the cylinder-shaped first circumferential segment 24 of the inner surface of the skirt 20 varies uniformly between two adjacent radii of the four equidistantly distributed radii 27a-27d.

According to various embodiments, the smallest inner circumference of the second circumferential segment 25 of the inner surface of the skirt 20 is greater than the greatest of: the circumference of the circular outer rim surface 17 of the container 13, and the inner circumference of the first circumferential segment 24 of the inner surface of the skirt 20.

During manufacturing of the lid 2 several forming steps are performed, preferably concurrently with each other. The method comprises the steps of forming the cover plate 19 and forming the skirt 20 connected to the cover plate 19, wherein the first circumferential segment 24 of the inner surface of the skirt 20 is given cylindrical shape and is located intermediate the second circumferential segment 25 and the cover plate 19. The method also comprises the step of forming the cylinder-shaped first circumferential segment 24 of the skirt 20 into non-circular shape, wherein the inner circumference of the first circumferential segment 24 is made equal to or less than 102% of the circumference of the circular outer rim surface 17 and is made equal to or more than 98% of the circumference of the circular outer rim surface 17.

### Feasible Modifications of the Invention

The invention is not limited only to the embodiments described above and shown in the drawings, which primarily have an illustrative and exemplifying purpose. This patent application is intended to cover all adjustments and variants of the preferred embodiments described herein, thus the present invention is defined by the wording of the appended claims and the equivalents thereof. Thus, the equipment may be modified in all kinds of ways within the scope of the appended claims.

Throughout this specification and the claims which follows, unless the context requires otherwise, the word “comprise”, and variations such as “comprises” or “comprising”, will be understood to imply the inclusion of a stated integer or steps or group of integers or steps but not the exclusion of any other integer or step or group of integers or steps.

It shall be pointed out that the final rigid cellulose product may be constituted by three or more segments, wherein each pair of neighbouring segments are joined/connected to each other according to the present invention.

1. A set comprising a container and lid,
the container comprising a container wall and an opening defined by a circumferential rim of the container wall, wherein said rim has a circular outer rim surface, and
the lid comprised of cellulose fibers, wherein said lid comprises a cover plate configured to cover the opening of the container and a skirt connected to the cover plate and configured to engage the circular outer rim surface of the rim of the container, and wherein a first circumferential segment of an inner surface of the skirt has cylindrical shape, said first circumferential segment being located intermediate a second circumferential segment of the inner surface of the skirt and the cover plate of the lid,
wherein the cylinder-shaped first circumferential segment of the skirt of the lid has non-circular shape, and in that an inner circumference of the first circumferential segment of the inner surface of the skirt is equal to or less than 102% of a circumference of the circular outer rim surface of the container and is equal to or more than 98% of the circumference of the circular outer rim surface of the container, wherein the non-circular cylinder-shaped first circumferential segment of the inner surface of the skirt of the lid is configured to engage the circular outer rim surface of the rim of the container.

2. The set of container and lid according to claim 1, wherein the first circumferential segment of the skirt of the lid comprises four equidistantly distributed radii wherein at least one radius of said four radii is the shortest radius of the first circumferential segment and is less than the radius of the circular outer rim surface of the container and is equal to or more than 98% of the radius of the circular outer rim surface of the container.

3. The set of container and lid according to claim 2, wherein said at least one radius of said four radii that is the shortest, is equal to or more than 99% of the radius of the circular outer rim surface of the container

4. The set of container and lid according to claim 2, wherein at least one other radius of the four radii is the longest radius of the first circumferential segment and is more than the radius of the circular outer rim surface of the container and is equal to or less than 102% of the radius of the circular outer rim surface of the container

5. The set of container and lid according to claim 4, wherein the at least one other radius of the four radii that is the longest, is equal to or less than 101% of the radius of the circular outer rim surface of the container (Currently Amended) The set of container and lid according to claim 1, wherein the lid is made of a heat-pressed sheet of air-laid cellulose fluff comprising cellulose fibers.

7. The set of container and lid according to claim 1, wherein the axial height of the first circumferential segment of the inner surface of the skirt is equal to or more than 1 mm and equal to or less than 5 mm, preferably equal to or more than 1.5 mm and equal to or less than 3 mm.

8. The set of container and lid according to claim 1, wherein the skirt of the lid has an outer surface located opposite the cylindrical first circumferential segment of the inner surface of the skirt, wherein said outer surface has a truncated cone shape.

9. The set of container and lid according to claim 1, wherein the second circumferential segment of the inner surface of the skirt has a truncated cone shape.

10. The set of container and lid according claim 1, wherein the second circumferential segment of the inner surface of the skirt has a smallest inner circumference greater than a greatest of the circumference of the circular outer rim surface of the container and an inner circumference of the first circumferential segment of the inner surface of the skirt.

11. The set of container and lid according to claim 1, wherein the cover plate of the lid has plane general shape, or convex general shape, or recessed general shape.

12. A lid to be used together with a container that comprises a container wall and an opening defined by a circumferential rim of the container wall, wherein said rim has a circular outer rim surface, the lid comprised of cellulose fibers and comprising a cover plate configured to cover the opening of the container and a skirt connected to the cover plate and configured to engage the circular outer rim surface of the rim of the container, and wherein a first circumferential segment of an inner surface of the skirt has cylindrical shape, said first circumferential segment being-located intermediate a second circumferential segment of the inner surface of the skirt and the cover plate of the lid,
wherein the cylinder-shaped first circumferential segment of the skirt of the lid has non-circular shape, and an inner circumference of the first circumferential segment of the inner surface of the skirt is equal to or less than 102% of a circumference of the circular outer rim surface of the container and is equal to or more than 98% of a circumference of the circular outer rim surface of the container, wherein the non-circular cylinder-shaped first circumferential segment of the inner surface of the skirt of the lid is configured to engage the circular outer rim surface of the rim of the container.

13. A method for manufacturing a lid made of cellulose fibers, wherein the lid is configured to engage a circular outer rim surface circumferential rim of a container, the method comprises the steps of:
forming a cover plate and forming a skirt connected to the cover plate, wherein a first circumferential segment of an inner surface of the skirt has cylindrical shape and is located intermediate a second circumferential segment of the inner surface of the skirt and the cover plate and
forming the cylinder-shaped first circumferential segment of the skirt into non-circular shape, wherein the inner circumference of the first circumferential segment of the inner surface of the skirt is equal to or less than 102% of the a circumference of the circular outer rim surface of the container and is equal to or more than 98% of a circumference of the circular outer rim surface of the container, wherein the non-circular cylinder-shaped first circumferential segment of the inner surface of the skirt of the lid is configured to engage the circular outer rim surface of the rim of the container.

14. The set of container and lid according to claim 3. wherein at least one other radius of the four radii is the longest radius of the first circumferential segment and is more than the radius of the circular outer rim surface of the container and is equal to or less than 102% of the radius of the circular outer rim surface of the container.

15. The set of container and lid according to claim 14, wherein the at least one other radius of the four radii that is the longest is equal to or less than 101% of the radius of the circular outer rim surface of the container.

16. The set of container and lid according to claim 8 wherein the second circumferential segment of the inner surface of the skirt has a truncated cone shape.

17. The set of container and lid according claim 16, wherein the second circumferential segment of the inner surface of the skirt has a smallest inner circumference greater than a greatest of the circumference of the circular outer rim surface of the container and an inner circumference of the first circumferential segment of the inner surface of the skirt.
